(19) United States
(12) Patent Application Publication
(10) Pub. No.: US 2025/0384401 A1
(43) Pub. Date: Dec. 18, 2025

(54) DYNAMIC FRONT END USER INTERFACE GENERATION SYSTEM WITH SHARED MULTI-LAYERED BACK END ARCHITECTURE

(71) Applicant: Scrap It Technology, LLC, Dallas, TX (US)

(72) Inventors: Garrett King, Plano, TX (US); Dominic Perry, Dallas, TX (US)

(21) Appl. No.: 18/743,469

(22) Filed: Jun. 14, 2024

(51) Int. Cl. G06Q 10/1053; G06F 9/451

(52) U.S. Cl. CPC G06Q 10/1053; G06F 9/451

(57) ABSTRACT

A job tracking platform based on multi-tenant architecture techniques in which a host instantiates an instance of a job tracking platform configured to provide job tracking and related services service to multiple tenants via corresponding virtual networks. A virtual host platform provides services and applications to serve multiple tenant users through user interfaces that are dynamically altered based on user and job events and data additions and updates are customizable by each tenant user.

### FIELD OF THE INVENTION

The present invention relates generally to systems operating on a multi-tenant architecture platform, and in particular a multi-tenant architecture platform having dynamically-altered user interfaces.

### BACKGROUND

The use of cloud-based applications, such as enterprise public cloud applications, third-party cloud applications, and the like, is increasing. Accessibility comes from many devices such as desktop and mobile devices. There are also many types of users, such as customers, vendors, contractors, sub-contractors, business owners, and the like. User's gain access to the presently described multi-tenant architecture job tracking system with dynamically altered user interfaces through a subscription or license agreement through enrollment according to known techniques.

A multi-tenant architecture refers to a system composed of dynamically-altered frontend user experiences while sharing the same backend layer and data stores. This approach requires lower maintenance and allows for greater speed to market (as opposed to a single tenant model), while still providing scalability required by the product through leverage of cloud infrastructure (e.g. auto-scaling and load balancing).

### BRIEF SUMMARY

Each licensee (Licensee A, B, . . . , etc.) of the presently described embodiments of a multi-tenant architecture job tracking system with dynamically altered user interfaces invokes its own branded version of the frontend user interface application that is determined at runtime according to organization identification, a configuration file, and an assets repository. Upon user login, that licensee's designated colors, loge and theme are inserted into the frontend interface, which permeates the various specific user interfaces herein described. An application program retrieves branded assets, such as a logo or trademark, from, in an embodiment, public cloud storage containers for objects stored in simple storage service (S3) format as designated by the licensee at runtime.

Utilizing an S3 repository allows for real-time updates of the described jobs platform that do not require code deployment. The application programs that provide users with the various interfaces and functionality herein described retrieve a licensee config file by organization ID from an S3 repository to dynamically inject branding such as primary, second, and tertiary colors for the user, either on an individualized basis or entity wide.

The application programs utilize an existing photos S3 repository for photo retrieval and storage for licensees. A new schema is created for each onboarded user for data segmentation and long-term flexibility. A cross-reference table is created to associate an organization ID to a licensee schema. A backend platform operator application program interface (API) dynamically injects the applicable email address to send notifications via a simple mail transfer protocol (STMP) from the licensee's email. The Backend API will leverage the platform operator's existing messaging account, such as Twilio MessagingX, to send SMS notifications to users' crew or customers from a single number and only for forwarding notifications.

Organizations are configured in a platform, such as Auth0 to manage licensees and their subscription, providing secure access to the multi-tenant architecture job tracking platform with dynamically altered user interfaces herein described. The backend application program supports both the platform provider's version of the platform as well as the user/licensee's version of the platform. In an embodiment, the presently described platform relies on a single data store for consistency, although multiple data stores or distributed storage may be employed. The platform operator's integrations with application programs to automate repetitive tasks, host real-time text, voice or video chats, and use visualization tools for data analytics and business intelligence are not impacted from the platform operator's perspective and optionally may be made available to user/licensee's, depending of the user subscription plan. Platform administrators leveraging online software development platforms for storing, tracking or collaborating on developing source code and web hooks for CI/CD are not impacted. At the same time, the platform operator sends monthly insights reports to licensees derived from analytics of customer data.

Platform and user integration with commercially available billing and accounting software allows for basic invoicing functionality. Integration with an address validation service is procured and configured to verify addresses provided for jobs. As described, the various services interface allows end users the ability to manage their service offerings within the platform. The various user interfaces allow user/licensees to tailor their services to their industry and business. Row-level-security is implemented for each licensee and the backend to protect data. A new services management user interface is created to allow users the ability to manage their service offerings within the platform and tailor their services to their industry and business.

One embodiment controls access to a resource, the access controlled by a multi-tenant system. Embodiment receive, at a web server, a request for the resource from a user via a web browser, the request including a Uniform Resource Locator (“URL”) associated with the resource and an identity of a tenant corresponding to the user. Embodiments determine an access policy for authenticating the user that is associated with the resource, the access policy based in part on the identity of the tenant. Embodiments then authenticate the user based on the determined access policy.

Network virtualization technologies enable service providers to create virtual, cloud based networks for their customers or “tenants” that are independent of the physical network and underlying hardware for their customers. Such virtual networks may be created on-demand without changes to the underlying physical network. Virtual networks are therefore relatively easy to set-up, manage and expand and may have a cost advantage over comparable physical networks.

Multi-tenant network stack techniques are described. In an implementation, a host instantiates an instance of virtual machine that is configured to serve networks service to multiple tenants and corresponding virtual networks. To do so, a framing layer of the virtual machine may be configured to obtain configuration data indicative of topology for a multi-tenant virtual networking environment from a virtual switch of a host device. The framing layer uses the configuration data to construct routing compartments and interfaces as abstractions of each virtual network in accordance with the topology. The routing compartments are isolated from each other and provide a mechanism for applications to process network input/output (I/O) in the context of a specific tenant or virtual network. The single virtual machine is able to provide services and applications to serve multiple tenants that are independent of the underlying virtualization technology. The multi-tenant network stack may support various virtualization technologies including at least NVGRE and VLAN. Additionally, the single virtual machine may be configured to serve virtual networks and construct routing compartments that use a combination of different supported virtualization technologies. In the following discussion, an example environment is first scribed that may employ the techniques described herein. Example procedures are then described which may be performed in the example environment as well as other environments. Consequently, performance of the example procedures is not limited to the example environment and the example environment is not limited to performance of the example procedures. Lastly, an example system and components of the system are discussed that may be employed to implement embodiments of the techniques described herein.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 depicts an example operating environment in accordance with one or more implementations according to the embodiments,

FIG. 2 depicts an example operating environment in accordance with one or more implementations according to the embodiments.

FIG. 3 depicts a user dashboard of user interface of a multi-tenant architecture job tracking system with dynamically altered user interfaces according to an embodiment.

FIG. 4 depicts a job list of user interface of a multi-tenant architecture job tracking system with dynamically altered user interfaces according to an embodiment.

FIG. 5 depicts a new job creation user interface of a multi-tenant architecture job tracking system with dynamically altered user interfaces according to an embodiment.

FIG. 6 depicts a users user interface of a multi-tenant architecture job tracking system with dynamically altered user interfaces according to an embodiment.

FIG. 7 depicts a new user addition user interface of a multi-tenant architecture job tracking system with dynamically altered user interfaces according to an embodiment.

FIG. 8 depicts a users user interface of a multi-tenant architecture job tracking system with dynamically altered user interfaces according to an embodiment.

FIG. 9 depicts a users user interface of a multi-tenant architecture job tracking system with dynamically altered user interfaces according to an embodiment.

FIG. 10 depicts a users user interface of a multi-tenant architecture job tracking system with dynamically altered user interfaces according to an embodiment.

FIG. 11 depicts an invoicing user interface of a multi-tenant architecture job tracking system with dynamically altered user interfaces according to an embodiment.

FIG. 12 depicts an invoicing user interface of a multi-tenant architecture job tracking system with dynamically altered user interfaces according to an embodiment.

FIG. 13 depicts an invoicing creation user interface of a multi-tenant architecture job tracking system with dynamically altered user interfaces according to an embodiment.

FIG. 14 depicts a customer list user interface of a multi-tenant architecture job tracking system with dynamically altered user interfaces according to an embodiment.

FIG. 15 depicts a new customer addition user interface of a multi-tenant architecture job tracking system with dynamically altered user interfaces according to an embodiment.

FIG. 16 depicts a crew list user interface of a multi-tenant architecture job tracking system with dynamically altered user interfaces according to an embodiment.

FIG. 17 depicts a new crew addition user interface of a multi-tenant architecture job tracking system with dynamically altered user interfaces according to an embodiment.

FIG. 18 depicts a service listing user interface of a multi-tenant architecture job tracking system with dynamically altered user interfaces according to an embodiment.

FIG. 19 depicts a new service addition user interface of a multi-tenant architecture job tracking system with dynamically altered user interfaces according to an embodiment.

FIG. 20 depicts a service editing user interface of a multi-tenant architecture job tracking system with dynamically altered user interfaces according to an embodiment.

FIG. 21 depicts a user dashboard notification listing user interface of a multi-tenant architecture job tracking system with dynamically altered user interfaces according to an embodiment.

FIG. 22 depicts an example operating environment of a multi-tenant architecture job tracking system with dynamically altered user interfaces in the embodiments.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiments disclosed, but on the contrary, the intention is to cover all modifications, equivalents, and alternatives falling within the spirit and scope of the present application as defined by the appended claims.

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

### DETAILED DESCRIPTION OF THE EMBODIMENTS

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Multi-tenant network stack techniques are described. In an implementation, a host instantiates an instance of virtual machine that is configured to serve networks service to multiple tenants and corresponding virtual networks. To do so, a framing layer of the virtual machine may be configured to obtain configuration data indicative of topology for a multi-tenant virtual networking environment from a virtual switch of a host device. The framing layer uses the configuration data to construct routing cc apartments and interfaces as abstractions of each virtual network in accordance with the topology. The routing compartments are isolated from each other and provide a mechanism for applications to process network input/output (I/O) in the context of a specific tenant or virtual network. The single virtual machine is able to provide services and applications to serve multiple tenants that are independent of the underlying virtualization technology. The multi-tenant network stack may support various virtualization technologies including at least NVGRE and VLAN. Additionally, the single virtual machine may be configured to serve virtual networks and construct rooting compartments that use a combination of different supported virtualization technologies.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures. Lastly, an example system and components of the system are discussed that may be employed to implement embodiments of the techniques described herein.

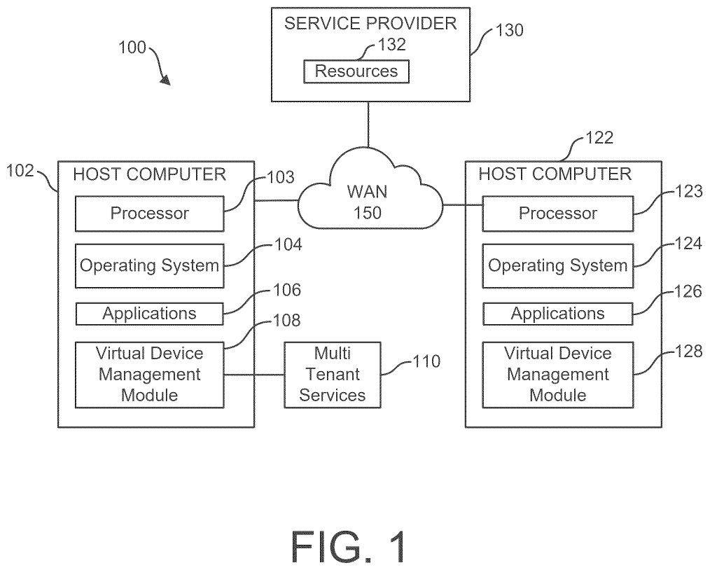

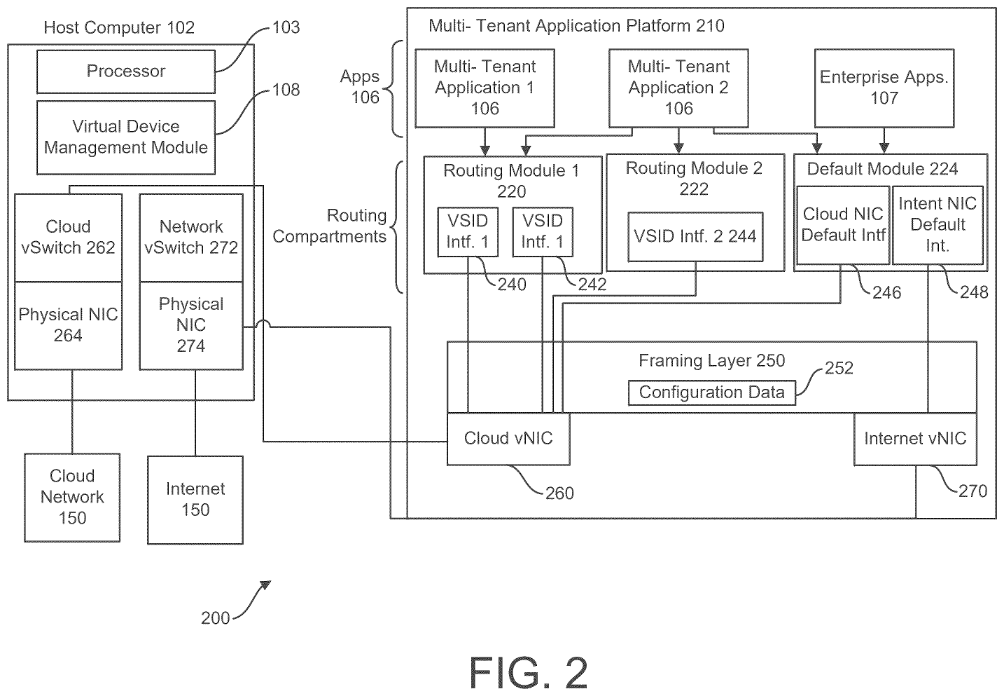

Referring now to the drawings wherein like reference characters identify corresponding or similar elements throughout the several views, FIG. 1 is an illustration of an environment 100 in an example implementation that is operable to employ techniques described herein. The illustrated environment 100 includes a first host computer 102, having a processor 103, a second host computer 122, and a service provider 130 that are communicatively coupled via a network 150, such as a wide area network such as the Internet. First host computer 102 having a first processor 103, second host computer 122 having a second processor 123, and service provider 130 may be implemented by one or more computing devices and also may be representative of one or more entities. Host computing devices 102 and 122 may also represent a virtual machine in a virtual networking environment, additional details of which are discussed in relation to FIG. 2 below.

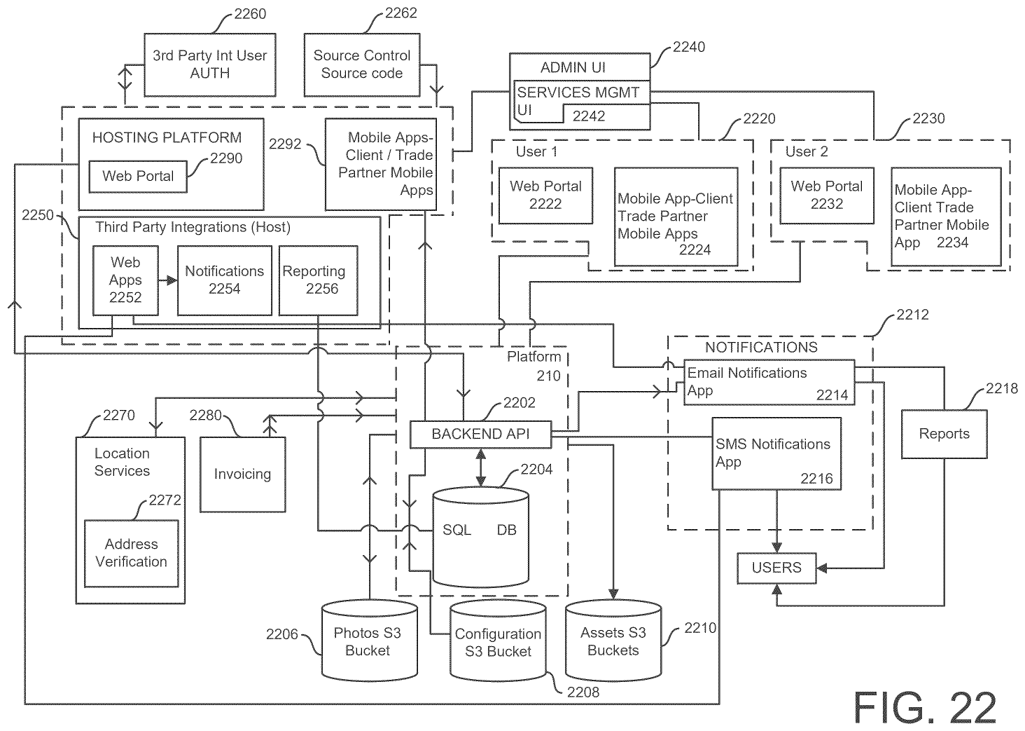

Service provider 130 in an embodiment makes a variety of resources 132 (e.g. content and services) available to clients of the network 150, which may include host computers 102 and 122. Generally, resources 132 made accessible by service provider 130 may include any suitable combination of services and/or content typically made available over a network by one or more providers. Some examples of services include, but are not limited to, a virtual networking service (e.g., cloud computing), a search service, an email service, an instant messaging service, an online productivity suite, and an authentication service to control access of clients to the resources. Content may include various combinations of text, multi-media streams, documents, application files, photos, audio/video files animations, images, web pages, web applications, device applications, content for display by a browser or other client application, and the like. An embodiment of such services and combinations are described in detail below in FIG. 22.

The computers described herein may be configured in a variety of ways. For example, a computing device may be configured as a computer that is capable of communicating over the network 150, such as a desktop computer, a mobile station, an entertainment appliance, a set-top box communicatively coupled to a display device, a wireless phone, a game console, and so forth. Thus, the computing device may range from full resource devices with substantial memory and processor resources (e.g., personal computers, tablets, etc.) to a low-resource device with limited memory and/or processing. Additionally, although a single computing device is shown in some instances, the computing device may be representative of a plurality of different devices, such as multiple servers of the service provider 106 utilized by a business to perform operations, provide a datacenter, and so on.

Although the network 150 is illustrated as the Internet, the network may assume a wide variety of configurations. For example, the network. 150 may include a wide area network (WAN), a local area network (LAN), a wireless network, a public telephone network, an intranet, and so on. Further, although a single network 150 is shown, the network 150 may be configured to include multiple networks.

Host computers 10 and 122 are each illustrated as including an operating system 104 and 124, respectively. Operating systems 104 and 124 are configured to abstract underlying functionality of the underlying device to applications 106 and 126 that are executable by the hosts. For example, the operating system 104 may abstract processing, memory, network, and/or display functionality such that the applications 106 may be written without knowing “how” this underlying functionality is implemented. Application program 106, for instance, may provide data to the operating system 104 to be rendered and displayed by a display device as illustrated without understanding how this rendering will be performed. A variety of applications 106 typically associated with hosts are contemplated including, but not limited to, a productivity suite that integrates multiple office productivity modules, a web browser, games, a multi-media player, a word processor, a spreadsheet program, a photo manager, and so forth.

The host computers 102 and 112 are also illustrated as each including a virtual device manager module 108 and 128, respectively. The virtual device manager module 114 represents functionality to manage the creation, operation, and termination of virtual machines. The virtual device manager modules 108 and 128 are also configured to enable multi-tenant network stack techniques described herein. For example, the virtual device manager modules 108 and 128 may be adapted to facilitate provision of multi-tenant services 110 by virtual machines managed via the virtual device manager module 108. As described in greater detail below, the virtual machine manager module 108 may instantiate a virtual device that implements a multi-tenant network stack. A single virtual device may service multiple virtual networks (also referred to as tenant networks) corresponding to different tenants/customers. In one approach, const acts referred to as rooting compartments corresponding to each virtual network serviced by a virtual machine are created in the network stack to abstract network layer state and isolate the virtual networks from one another. Multi-tenant services 110 and corresponding applications may therefore operate and handle network input/output (I/O) within the context of a particular virtual network using an appropriate routing compartment. The support for multi-tenancy provided via the virtual machine device module 108 and routing compartments may be independent of network virtualization technology employed for the virtual networks. Additionally, multiple different network virtualization technologies may be supported by the same instance of a virtual device. Details regarding these and other aspects of multi-tenant network stack techniques are discussed in below in relation to the figures.

In general, multi-tenant network stack techniques described above and below may be implemented by physical devices and components (e.g., routers and switches) as well as by virtual machines, switches, and other components in a virtual networking environment. Combinations of physical and virtual machines/devices are also contemplated. In the following discussion, some examples and details are discussed in relation to a virtual networking environment that may include multiple virtual machines. The described techniques, however, are equally applicable to networks of physical computing devices and “mixed” networks that include a mix of physical computing devices and virtual machines. For example, the multi-network stack as described herein in a virtual machine context may alternatively be implemented natively by a traditional physical computing environment.

FIG. 2 depicts architecture 200 for a multi-tenant virtual platform 210 in accordance with one or more of the embodiments. Architecture 200 is configured to support management of multiple virtual networks associated with multiple different tenants via a single instance of a virtual machine. The multiple virtual networks served by the virtual machine may employ the same or different network virtualization technologies. Each virtual machine may be configured to serve many virtual networks for tenants (e.g., rooting domains) on the order of hundreds, thousands, or even more individual virtual networks.

Architecture 200 enables multi-tenancy aware services and application that can process network I/O in the context of a particular tenant, virtual network and/or routing domain. The multi-tenant network stack implemented via the virtual device provides isolation across different routing domains to prevent packets from being leaked unintentionally between two routing domains. Further, architecture 200 facilitates management of the virtual network set-up and operation for multiple tenants as well as allocation of shared services and resources including bot not limited to processing system usage, network bandwidth, memory, and so forth. A multi-tenant virtual platform operates independently of the underlying virtualization scheme. For example, support may be provided for both VLAN based multi-tenancy and NVGRE based multi-tenancy as well as other comparable virtualization technologies by the same instance of a virtual device. In addition or alternatively, different instances of a virtual device may be created to handle different respective virtualization technologies.

As depicted in FIG. 2, a host computer 102 having processor 103 instantiates an instance of multi-tenant platform 210 that implements a multi-tenant network stack. As shown, the host computer 102 may include a virtual device management module 108 that is multi-tenancy aware as discussed in relation to the example host computer 102 of FIG. 1, used in FIG. 2. The virtual device management module 108 operates as discussed previously to enable set-up and creation of virtual machines through the host computing device, including the example multi-tenant virtual platform 210.

Multi-tenant platform 210 is depicted as having framing layer 250 and routing compartments 220, 222, and 224 to support various applications 106. Some of applications 106 may be multi-tenant applications that provide services and/or processing to virtual networks associated with different tenants. Additionally, the routing modules 220, 222 and 224 are illustrated as including respective interfaces 240, 242, 244, 246 and 248 that are created as network layer abstractions for respective virtual networks and virtual subnetworks. Interfaces 240, 242, 244, 246 and 248 may be established for each subnetwork and may associated w isolation identifiers that can be used to distinguish between the interfaces and isolate traffic for the subnetworks, such as virtual subnet IDs (VSIDs), VLAN IDs, or other suitable isolation identifiers corresponding to different virtualization schemes. The VSIDs described are provided as illustrations of the general concept of associating isolation identifiers with compartments/interfaces. Any suitable isolation identifiers may be employed to distinguish between and isolate the compartments/interfaces.

The embodiment shown in FIG. 2 also illustrates virtual network adapters (vNICs) for the virtual platform 210, which include cloud vNIC 260 and Internet vNIC 270 provide connectivity to a cloud network associated with virtual network workloads and the Internet, respectively. For example, the cloud vNIC 260 may be connected to a cloud vSwitch 262 associated with a physical NIC 264 (e.g., physical interface) of the host computer 102 to enable access to the cloud network 108. The Internet vNIC 270 may be connected to an Internet vSwitch 272 associated with a physical NIC 274 of host computer 102 to enable access to the Internet 108.

Framing layer 250 may query or otherwise obtain configuration data 252 that describes topology of the virtual networks and domains that the multi-tenant platform 210 is configured to serve. Configuration data 252 may be generated through interaction with the virtual machine manager module 108 and exposed to the multi-tenant platform 201 via a virtual switch or otherwise. The framing layer 250 is operable to generate routing modules 220, 222, and 224 in accordance with the topology described by configuration data 252. Framing layer 250 may also create interfaces 240, 242, 244, 246 and 248 for the various subnets as defined by the configuration data 252. Framing layer 250 may also generate and maintain a directory, database, table, or other suitable data structure that contains information to map virtual networks to subnets and routing compartments as well as routing compartments to the interfaces. For example, the data structure may be configured to map isolation identifiers to corresponding compartments/interfaces. This data structure of mapping directory may be referenced to pass network I/O for handling to appropriate routing compartments/interfaces and to route outgoing packets to appropriate endpoints. The mapping directory or data structure may also be made available to multi-tenancy aware services and applications. Routing modules 220, 222, 224 and associated interfaces 240 and 242 (for module 220), interface 244 (for module 222), and interfaces 246 and 248 (for default module 224) for mapping information implemented via framing layer 250 establish a mechanism to handle input/output within the context of a particular virtual network/routing domain and in isolation from traffic associated with other tenants/domains served by the multi-tenant platform 210.

Continuing with FIG. 2, multi-tenant platform machine 210 is configured to serve two virtual networks/rooting domains, which may correspond to a first tenant, Tenant 1 and a second tenant, Tenant 2. The arrangement may be established by an administrator via a configuration dialog provided by device management module 108, which produces corresponding configuration data 252. Framing layer 250 then uses the configuration data 252 to create appropriate components to handle and isolate the virtual networks/routing domains. In particular, routing module 1 220 and routing module 2 222 are in one embodiment created via framing layer 250. In this example, routing module 1 220 is associated with two virtual subnetworks represented VSID interface 1 240 and VSID interface 2 242. Routing module 2 is associated with a virtual subnet represented by VSID interface 244. Accordingly, framing layer 250 also creates VSID Interface λ 240 and VSID interface 2 242 for VSID routing module 1 220 and VSID interface 3 244 in Routing module 2 222. In one embodiment, the virtual networks both employ NVGRE although a different virtualization scheme or mixed schemes may be employed. Default module 224 having a cloud default interface 246 and Internet default interface 248 may also be created to handle traffic that is not designated for a particular routing domain.

In this arrangement, multi-tenant applications may be configured to do network application 1 106 in an embodiment operates in the context of module 1 220. A second multi-tenant application 106 is configured to operate in the context of module 2 222 and the default module 204. Multi-tenant applications 106 provide services in relation to multiple virtual networks and corresponding tenants using the routing module constructs to isolate the activity for the different contexts. Enterprise applications 107 (an application that is not multi-tenant aware) is able to perform network I/O in the default module. Enterprise applications 107 may be supported via the default module 224 and operate within the multi-tenant network stack without having to make modifications to the enterprise applications.

Routing modules 220 and 222 provide a mechanism for applications to perform network I/O in the context of a particular module. Additionally, a routing module can be set at a session, process, thread, and/or socket level to provide variable control to the services to handle various usage scenarios. Each virtual subnetwork may be exposed as a separate network layer interface inside a routing compartment. The multi-tenant services and applications can then bind the socket to the IP address of a particular interface 240, 242, 244, 246, 248 inside a given rooting module 220, 224, 226 to process network I/O in the context of the corresponding virtual subnet.

The routing modules 220 and 224 enable configuration and management of various network communication related policies, rules, and controls on an individual per routing module and/or per tenant basis. Thus, different compartments of the multi-tenant virtual platform may implement different policies, rules, and controls for handling and routing network traffic. By way of example and not limitation, firewall rules may be configured specific to a routing compartment for a tenant. In addition, bandwidth control policies and resource reservation control mechanisms such as Quality of Service (QOS) related features and controls may be implemented on a per compartment and/or per tenant basis. Additional network policies, including at least network security policies, traffic isolation policies and network monitoring policies may also be configured specific to a routing compartment for a tenant. Accordingly, the multi-tenant stack through the various routing compartments provides a mechanism to set-up various controls and management features for handling and routing of network communication on a per compartment basis and/or per tenant basis. Moreover, these management features may be implemented via the routing compartment in a manner that is independent of the underlying virtualization technology of corresponding virtual networks.

The architecture as described provides multi-tenancy support that is neutral with respect to the underlying isolation mechanism and virtualization technology. A multi-tenancy configuration may expose two modes of isolation, e.g., VSID based and VLAN based. Framing layer creates routing modules configured to handle traffic in a corresponding isolation mode. Framing layer may also be configured to distinguish between packets that use different isolation modes based on isolation identifiers and direct the packets to appropriate components for processing accordingly. This approach makes it possible for the system to support both VSID and VLAN based isolation solutions. Moreover, the same virtual platform may be configured to include modules for both virtual networks that leverage various virtualization schemes. Advantageously, the architecture is independent of and extendable with respect to the virtualization technologies used for the underlying virtual networks.

Implementation and functionality of the dynamically altered frontend user interfaces generated by multi-tenant platform of the present invention according to the various embodiments is now described. The frontend user interface consists of a web portal (usually for administrators) and a mobile application program, published to common repositories for user retrieval of such programs, such as the Apple and Google Play application program stores.

The web portal is accessible via a frontend website hosted on a unified cloud to build and run application programs and websites. Users and platform provider environments are set up by the multi-tenant platform operator. The operator creates enrollment mechanisms for users to subscribe to the platform, establish user accounts, credential authorized users with means for logging into the platform, establish payment methods and the like.

Once a user is subscribed, the user can provide credentials to other users within the user organization. The platform operator may establish a flat fee as the subscription price, or set a fee according to the user's number of internal individual users who will be accessing the platform.

Once a user account is established, a frontend interface representing a home page is presented to the user. A daily dashboard showing data such as job progress, count of jobs for a future time span (day, week, month), a map of current day's jobs with filters (via web API), invoice queue count, and total revenue for a predefined period (year-to-date, etc.).

The dashboard, in an embodiment, contains a table view of all jobs for the current day, a specific date, a previous time period, a future time period, or all time past and/or future. The user searches or filters jobs, selects for editing existing jobs, and creates new jobs, new services, identifies new crews and crew members and enters new customers of the user within the system. Users can also mass upload jobs to create them via a CSV upload.

Users have different roles, including administrative, customer, crew leader and crew members. Platform access, credentials and privileges are set by the administrator and/or the platform provider based on customization objectives or the level of subscription pricing. A customer is provided with limited login credentials by the user to track progress of a customer's job. Users are created, modified and invited from this page.

As jobs are completed, they are queued from the homepage into an invoicing module. Jobs can be combined or pushed to an invoice, which can be edited, sent via email, downloaded as a PDF, or synced to commercially available accounting and billing software. At any point, an billing software syne can occur from the invoicing user interface. In an embodiment this is a feature flag in the system that is enabled is enabled by the platform operating for the user, optionally at an additional subscription fee.

A list of customers is compiled and presented via a customer user interface The customer list is optionally synced with the billing software. Each customer is identified by a company or individual name, address and billing information. Additionally, customers contain contacts, projects and metrics. A customer is deemed active/inactive on the customer user interface depending on that customer's level of activity according to predefined parameters

A crew user interface present to the user a list of crew names associated with the user. Crews are identified according to a crew name (group or lead individual) and location.

Via a settings interface, that in an embodiment is accessible through selection of a dedicated selection key found on the various user interface screens, an administrator activates or deactivates various custom fields of the individual user interfaces. The fields and their presentation are customizable by each user to accommodate the individual preferences for the presentation of data of interest collected during job execution. An administrator, a crew member and a customer may each have different preference for viewing data and each may customize the frontend interfaces that they will interact with accordingly.

Custom information about the user entity and other preferences are also incorporated. The user adds or imports information such as branding text and/or images (logos), or other thematic elements of the frontend user interfaces, such as color and layout. can add information here about their company that shows on invoices generated-a company logo, name and address. The user can also adjust the main billing email for their environment, adjusting the customer reply-to on default communication sent form the platform.

A mobile portal, expected to be used by crews out in the field performing jobs, makes job list tabs containing a crew or crew member's jobs visible. The crew member accesses job information requiring attention for that day's jobs or jobs scheduled in the future, or information on past jobs. Crew member through the crew interface report a a job, push a job, or restart a job if it needs to be delayed. Crew members view job details, access the address to route (via a map application), and upload additional information as required that is associated and linked to the job, such as photos, status messages, arrival time, requests for a particular person or item, etc. A settings tab includes an option for a administrator to delete a user account and for users to log in and out of the platform through entry of known techniques. Users of the mobile application also receive push notifications based on actions taken in the web portal related to their user account.

In an embodiment, a customer portal, accessible through a mobile device equipped with a dedicated application program or via a URL address accessible by a mobile device or a desktop device, includes frontend user interfaces through which a customer's jobs associated with the user/licensee are accessible. The customer through a book jobs tab requests and books a job to be performed by the user and associated crew(s).

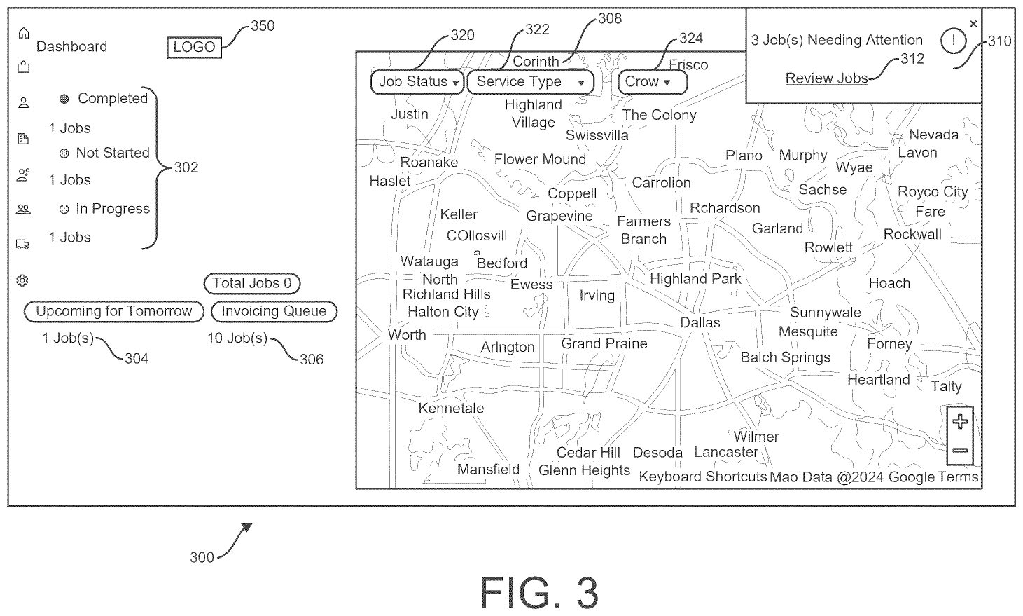

A Job List interface presents customer's jobs, where customers access their jobs for today, past or future dates and review photos, or request to cancel/reschedule if the job has not been completed or for any other reason. The following provides a description FIGS. 3 through 21, which depict the various user interfaces generated by a user according to the embodiments of a multi-tenant architecture job tracking platform with dynamically altered user interfaces herein described. The interfaces depicted and described are in no means exhaustive because of the flexibility, functionality and customizability of the presently described platform, which will be appreciated and understood as such by those skilled in the relevant art.

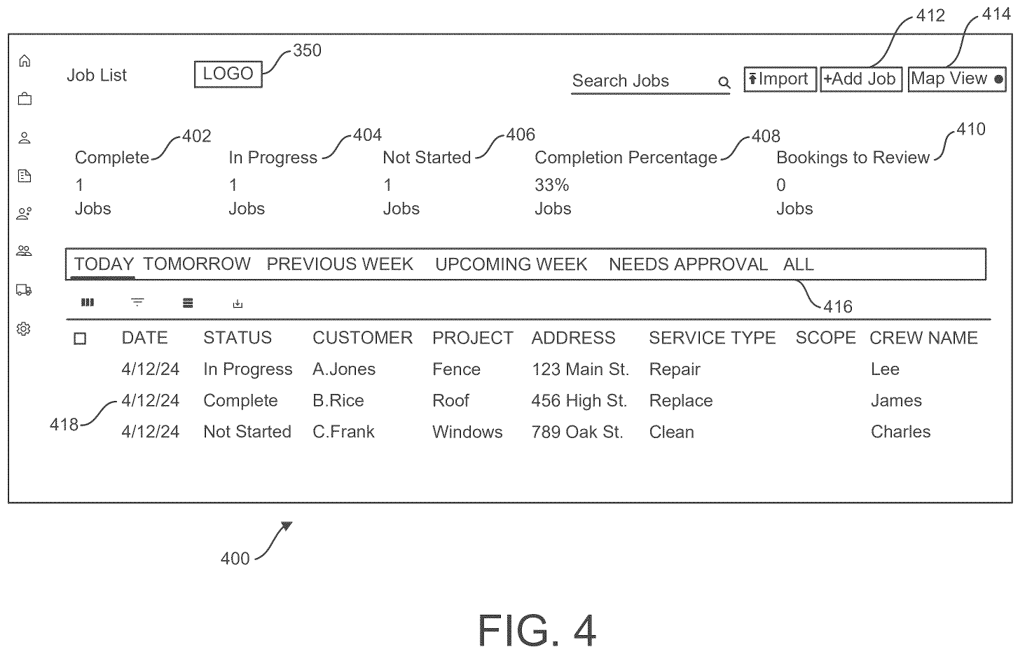

FIG. 3 depicts a user dashboard of user interface of a multi-tenant architecture job tracking system with dynamically altered user interfaces according to an embodiment. In FIG. 3, user dashboard interface 300 is shown. User dashboard interface 300 includes job status area 302 that identifies the number of jobs completed, the number of jobs that are in progress, and the number of jobs that have not started. As will be discussed in connection with FIG. 4, once a job status changes, the totals in job status area 302 are updated to reflect the current totals. User dashboard interface 300 includes upcoming jobs field 304, that indicates the number of jobs designated to begin within a predefined period, in the case shown, the next day. Invoicing queue field 306 depicts the number of job invoices that are in the queue for processing. Map region 308 depicts an excerpt of a geographic location in which a job will, is or has taken place. The user selection of job status drop down menu 320, service type drop down 322 or crew drop down 324 will prompt an indication on map region of the location of the jobs having the selected status, jobs of a particular service type and/or a crew. User dashboard interface 300 also includes tally region 310 indicating the number of jobs requiring attention, with a review jobs link 312 presenting the user with job information upon its selection.

User dashboard interface 300 includes logo field 350 into which a user or user organization can upload a company trademark, logo or other brand symbol to customize the user interface. In an embodiment,

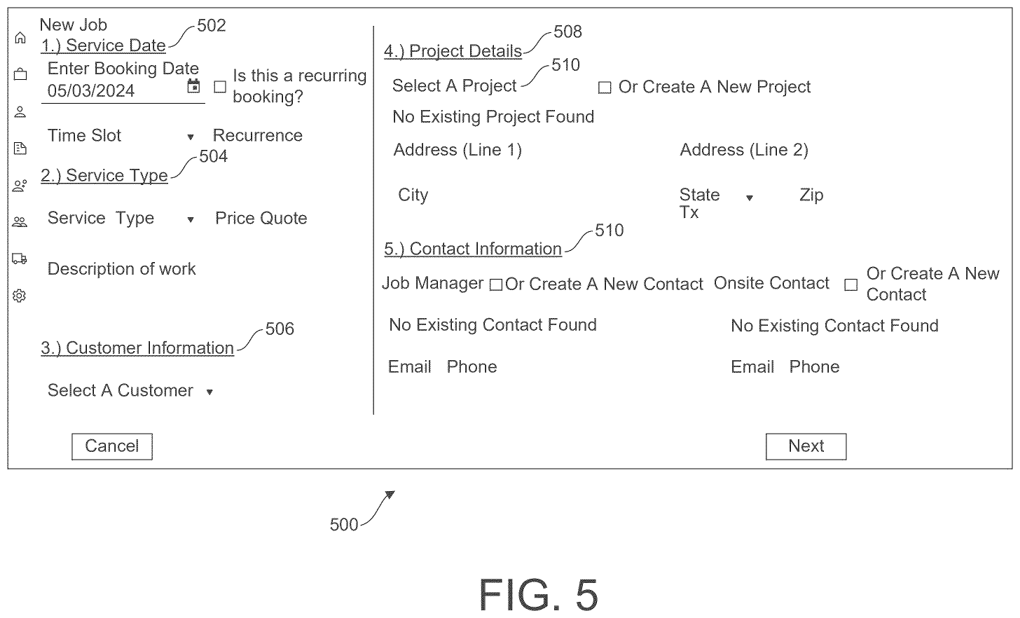

FIG. 4 depicts a job list user interface of a multi-tenant architecture job tracking system with dynamically altered user interfaces according to an embodiment. Job list user interface 400 provides a status of various jobs at varying levels of completion. Job list user interface 400 includes jobs complete field 402, jobs in progress field 404, and jobs not started field 406. Also shown are percentage field 408 and bookings to review field 410. Percentage filed 408, identifies the percentage of all jobs that are completed. Other statistics, such as percentage of jobs not started or percentage of jobs in progress optionally are shown in percentage field. Job list user interface 400 further includes add job selector 412 and map view selector 414. Add job selector 412, when selected by the user prompts presenting new job user interface, as will be discussed in connection with FIG. 5, through which the user adds new jobs that when stored are presented in job status field 418 of job list user interface 400. Map view selector when selected toggles to a map view that depicts a representation on a map of the location of a select job or jobs.

Job status field 418 provides various data associated with a given job, including a job date, a job status, a customer name, the project type, the address of the job, the service type, the scope of the job and the name of the crew and crew member (if assigned) associated with the job. Job list user interface 400 includes the user's logo field 350 where the user's selected brand, trademark or identifier is presented according to the user defined parameters.

FIG. 5 depicts a new job creation user interface of a multi-tenant architecture job tracking system with dynamically altered user interfaces according to an embodiment. New job creation user interface 500 includes fields where the user adds data about a newly entered job. The data includes data entered in service data field 502, including a job starting date, a time slot for the start of the project and, if a recurring booking option is selected, the frequency of the recurrent service. Service type field 504 is for data entry of the service type, the price quoted for the project and a description of the work to be performed. An existing customer for which the job will be done is entered selected via a dropdown in customer information field 506. The user enters project details in project details field 508. In project details field 508, the user selects an existing project or indicates that the project is not preexisting and a new project will be defined. The address of the new project is entered in project details field 508. Contact information field 510 is for user selection of a job manager and onsite contact. If the job manager or onsite contact person are preexisting, meaning they have been associated with other jobs, then their respective names will appear in a drop down menu. If not, the user indicates via appropriate box selection or other known methods that the individual's name is not in the system. A new contact or manager is added with that persons email address and phone number entered. Once the information entered on new job creation user interface 500 is stored, this information will appear in job status field 418 of FIG. 4, as described.

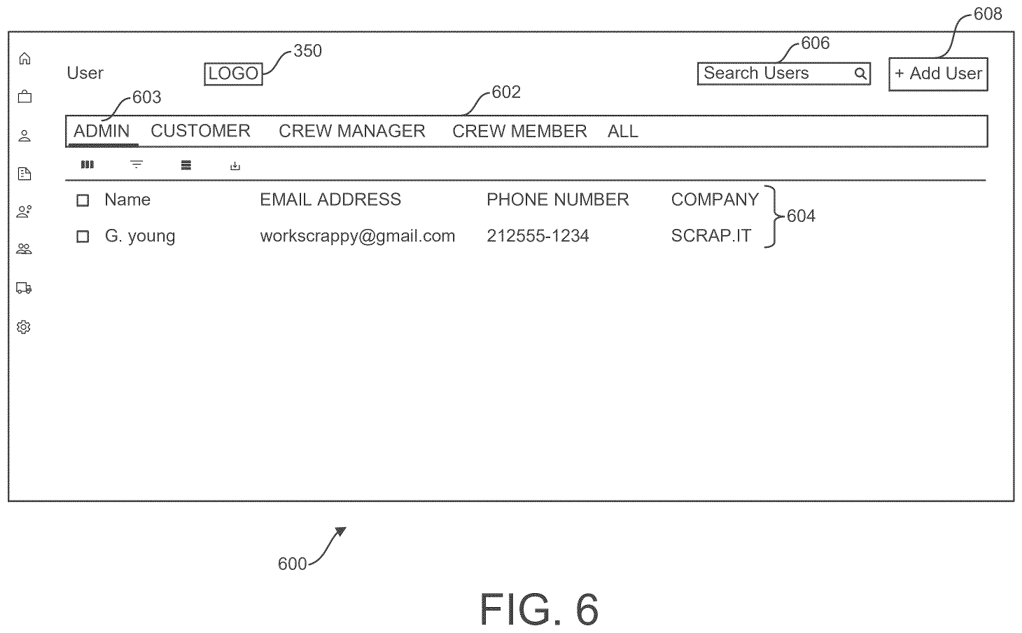

FIG. 6 depicts a users user interface of a multi-tenant architecture job tracking system with dynamically altered user interfaces according to an embodiment. Users user interface 600 provides an interface for entry of authorized licensee users of the multi-tenant architecture job tracking system with dynamically altered user interfaces of the enterprise licensing the platform from a provider. Users user interface 600 includes user type header 602 that includes selectable tabs or links that a user selects to populate users user interface 600. The user types identified in user type header 602 include administrative, customer, crew manager, crew member or all. Administrative refers to administrative personnel that might be responsible for data entry or management of the platform on behalf of the enterprise licensee. User data field 604 is populated to include the user's email address, phone number, company name as previously entered. Similar information is presented for each type of user. Under the “all” tab in user type header 602, all of an enterprise licensee's defined users are listed. If the administrator or other authorized or credentialed user of the multi-tenant architecture job tracking system with dynamically altered user interfaces platform adds a user by first selecting add user selector 608. A user searches for other users or relevant terms via search field 606.

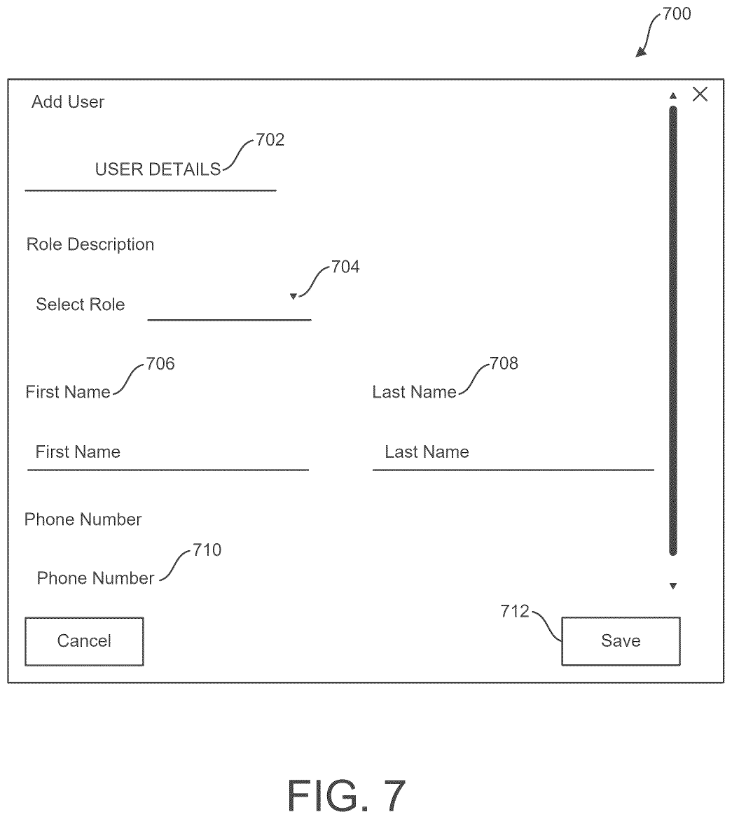

FIG. 7 depicts add user interface of a multi-tenant architecture job tracking system with dynamically altered user interfaces according to an embodiment. Add user interface 700 is invoked upon user selection of add user selector 608 of FIG. 6, as described. Add user interface includes user details field 702 that includes user role drop down menu 704 or other means from which to select a user role from a listing of predefined user roles. Recall from FIG. 6, a user role includes administrative, customer, crew manager, and crew member. Once a role is defined, the new user's first name, last name and phone number are entered in first name field 706, last name field 708 and phone number field 710. Once the data is entered, the user depresses save key 712, at which time the new user information is stored and the information appears in user data field 604 of FIG. 6.

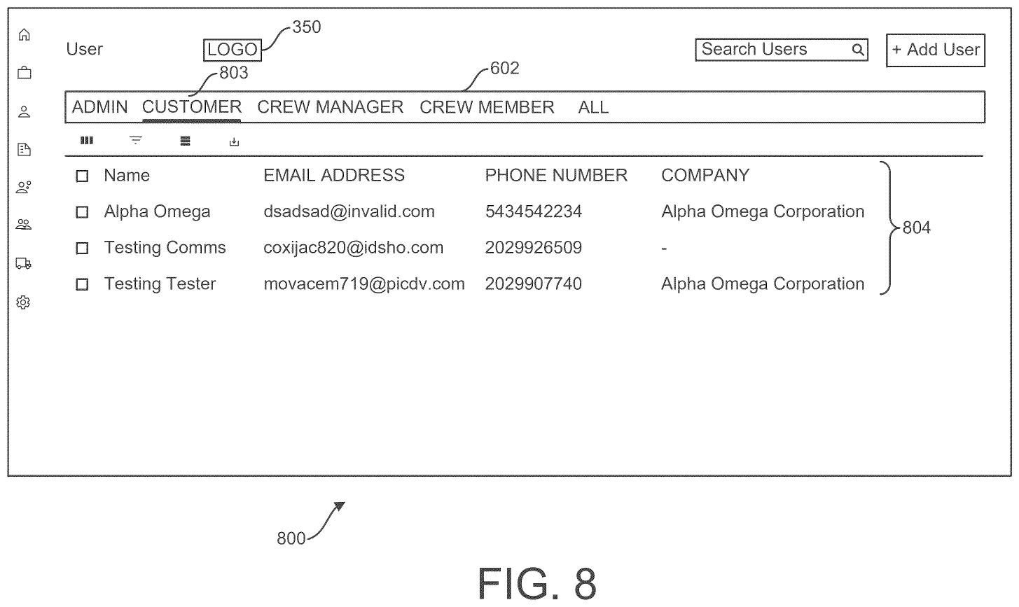

FIG. 8 depicts customer user interface of a multi-tenant architecture job tracking system with dynamically altered user interfaces according to an embodiment. Add customer user interface 800 is similar in various respects to add user interface 600 for administrators. User type header 602 that includes selectable tabs or links that a user selects to populate customer user interface 800. In FIG. 8, customer tab 803 is selected, resulting in population of customer user field 804 with customers that have been entered into the platform. Note that the licensee's brand or logo is depicted in logo field 350 along with any other color combination or theme designated by the licensee.

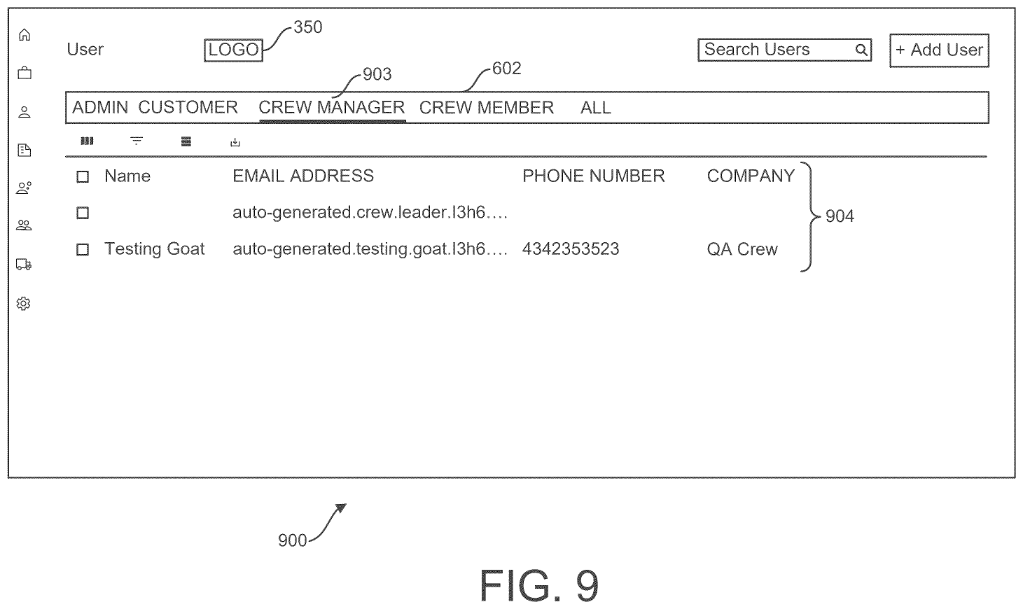

FIG. 9 depicts crew manager user interface of a multi-tenant architecture job tracking system with dynamically altered user interfaces according to an embodiment. Crew manager user interface 900 is similar in various respects to administrative user interface 600 and customer user interface 800 as described. User type header 602 that includes selectable tabs or links that a user selects to populate customer user interface 900. In FIG. 9, crew manager user tab 903 is selected, resulting in population of crew manager user field 904 with crew managers that have been entered into the platform. A presentation of crew member user field via selection of the “crew member” as the type of user in user type header 602 will cause display of crew member user information in similar fashion. Note that the licensee's brand or logo remains in logo field 350 along with any other color combination or theme designated by the licensee.

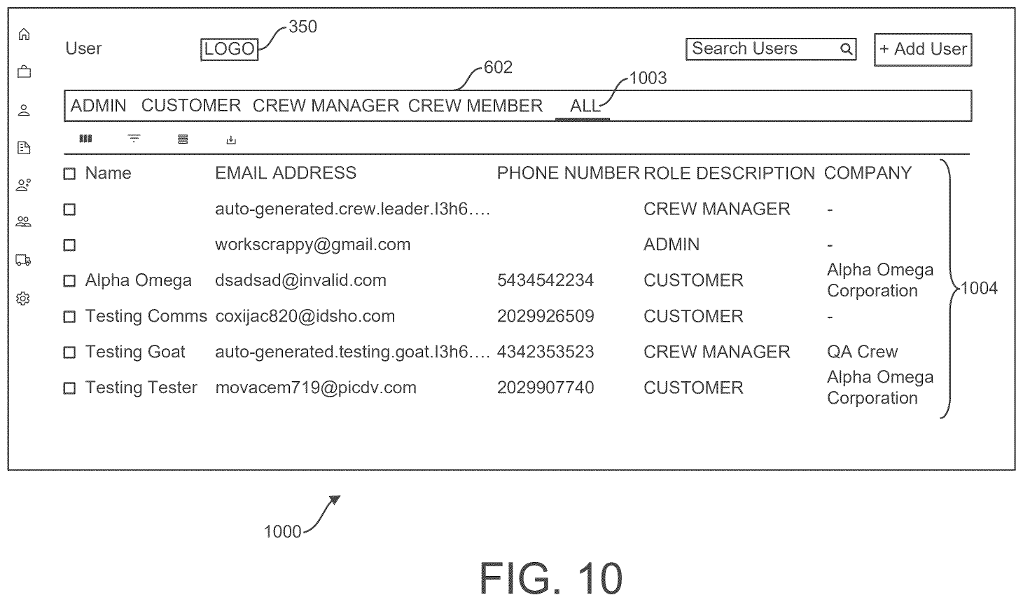

FIG. 10 depicts all users interface of a multi-tenant architecture job tracking system with dynamically altered user interfaces according to an embodiment. All users interface 1000 is similar in various respects to the other users interfaces as described. User type header 602 that includes selectable tabs or links that a user selects to populate customer user interface 1000. In FIG. 10, all users tab 1003 is selected, resulting in population all users in all users field 1004 with users that have been entered into the platform.

New users, whether administrative personnel, customers, crew managers or crew members are added to the user database for presentation in the appropriate user field is done through entry of data for adding a new user via the various add user interfaces described with respect to FIG. 7.

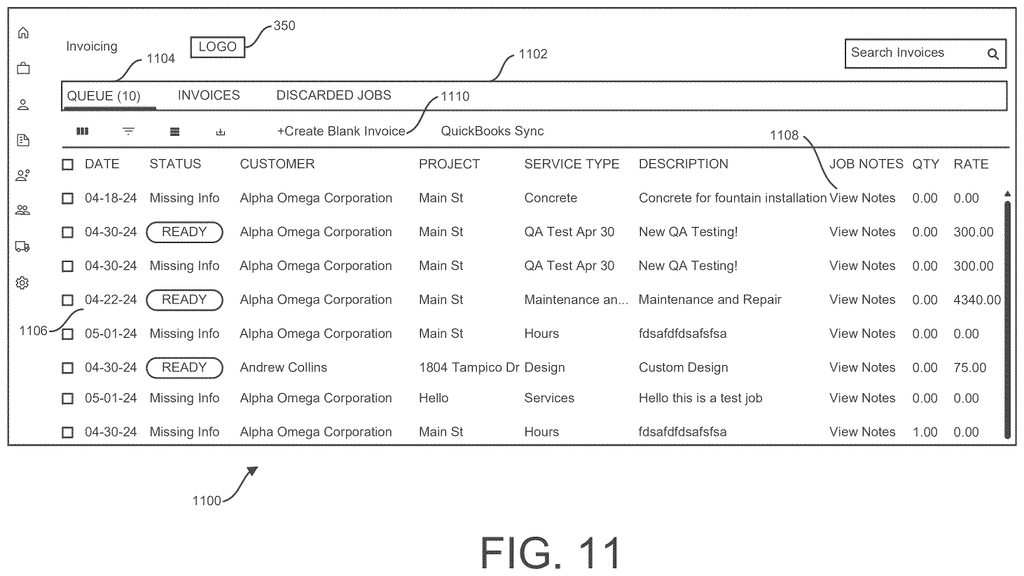

FIG. 11 depicts a queued invoice user interface of a multi-tenant architecture job tracking system with dynamically altered user interfaces according to an embodiment. Queued invoice user interface 1100 includes invoice status bar 1102 that includes selectable tabs for queued invoices 1104 (selected in FIG. 11), invoices tab and discarded jobs tab. Queued invoice data field 1106 includes various items of information pertaining to an invoice that it in the queue to submit to a customer or other party for payment. Queued invoice data field 1106 includes an invoice date field, an invoice status field, a customer field, a project location field, a service type field, a project field, a notes field (includes job, custom, project and crew notes), a quantity field, and a rate field. Invoice data field indicates the date an invoice was created. Invoice status field denotes the status of an invoice. As shown, an invoice is either ready to submit to a customer or missing information. If the latter, some item of data must be added to the invoice to complete it. This can be done by the user via in-line editing. In one embodiment, certain fields are flagged with a colored border to provide a visual offset for the user to prompt the user to enter or adjust any necessary information that is missing. Customer field identifies the name of the customer. Project field identifies the project by location, such as a street, known building or landmark, etc. Service type field identifies the type of service performed or goods provided. The description field identifies the type of services performed. Job notes field includes informational notes from a crew member or customer or other person associated with the job. Quantity refers to the units provided to the customer for the item or service of the job. Rate is price, either per unit cost or hourly labor cost associated with the job, that is multiplied by the value in the quantity field to arrive at an invoice total or subtotal for the goods or services.

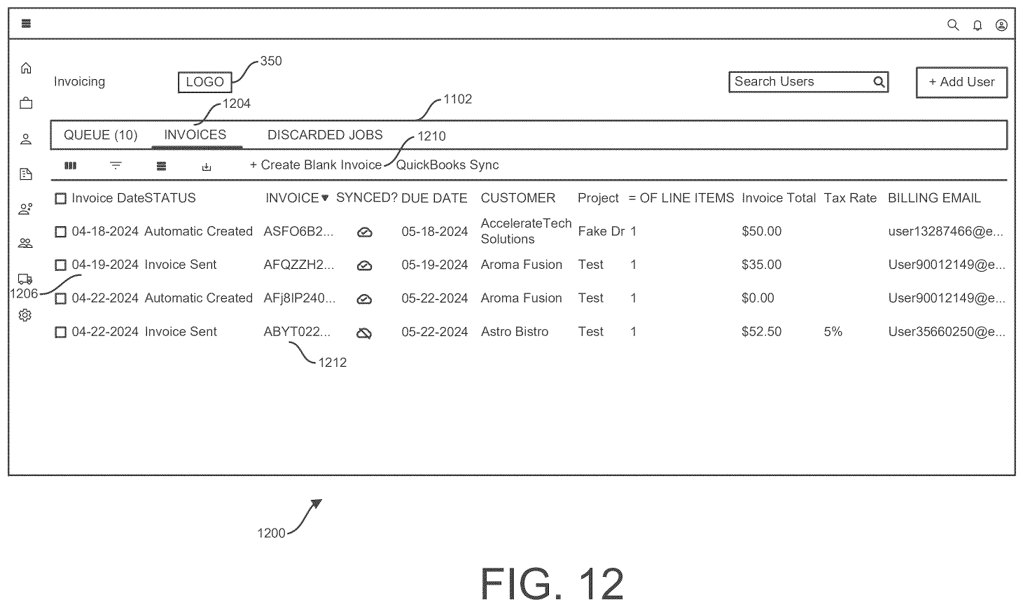

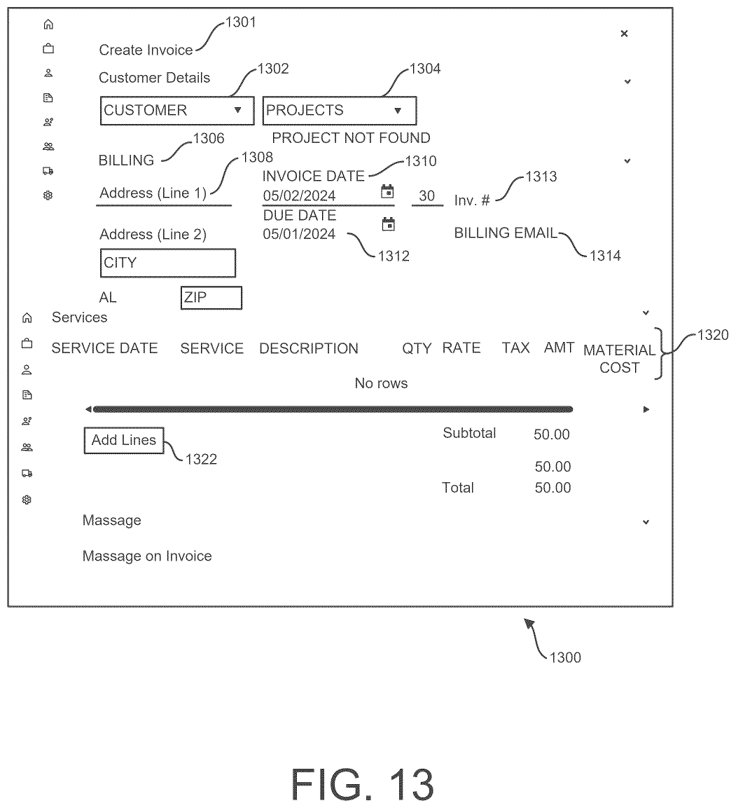

FIG. 12 depicts a completed invoice user interface of a multi-tenant architecture job tracking system with dynamically altered user interfaces according to an embodiment. In FIG. 12, completed invoice user interface 1200 includes invoice status bar 1102 that includes selectable tabs for completed invoices 1204 (selected in FIG. 12), queued invoices tab and discarded jobs tab. Completed invoice data field 1206 includes various items of information pertaining to an invoice that is completed, meaning it has been removed from the queue and includes all the necessary data to send to the customer or has been sent. Completed invoice data field 1206 includes an invoice date field, a status field, an invoice number field, a synced field, indicating whether the invoice has been linked to the user's accounting software, an invoice due date field, a customer name field, a project name field, a number of line items field, indicating the number line items on the invoice, the invoice total, the tax rate applied, if necessary, and the email to which the invoice is to be sent. Create blank invoice selector 1210, when selected by the user, causes a new create invoice interface to be presented to the user for entry of invoice data, as will described with respect to FIG. 13. Invoice number field 1212, in one embodiment, is a unique identifier associating the invoice to a particular customer. Note that the licensee's brand or logo remains in logo field 350 of an invoice listing along with any other color combination or theme designated by the licensee.

FIG. 13 depicts an invoicing creation user interface of a multi-tenant architecture job tracking system with dynamically altered user interfaces according to an embodiment. Invoice creation user interface 1300 includes customer details field 1301 that includes customer drop down 1302 for selection of the customer to be invoiced and projects drop down 1304 to include the appropriate project. If the subject project is not found, it is entered separately by the user. Billing field 1306 includes address fields 1308, which in an embodiment are prepopulated according to the customer selected. Invoice date field 1310 is for user selection of an invoice date by selecting a date from a representation of a calendar or via manual entry of the date. Due date field 1312 is the date by which payment is due. Invoice number field 1313 contains a unique invoice number either sequentially generated or manually entered by the user. An email address to which the invoice is to be sent is entered in billing email field 1314.

Invoice attributes field 1320 includes various user selected parameters and associated data that the user wishes to include on the invoice. Invoice attributes field includes a service date, a service description, a quantity of goods or time units of services, a rate in monetary units for one unit of the goods or a time duration of the service provided, a tax rate to be applied and total amount for the line item. Material cost is also included in attributes field 1320 if selected by the user. When the user selects add lines selector 1322, appropriate fields or selectable drop-down lists are provided to the user to input data for the service item. A subtotal, amount of tax and invoice total is tabulated upon population of the fields in a line item. In one embodiment, a discarded jobs tab is also an option for selection from invoice status bar 1102, jobs moved to discarded that will not be invoiced.

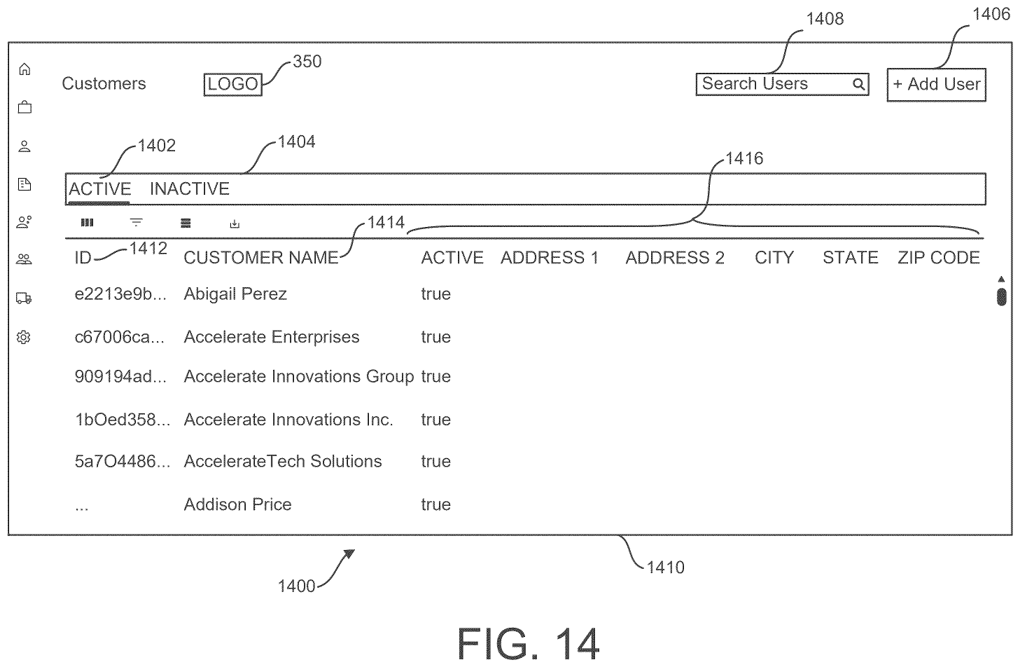

FIG. 14 depicts a customer list user interface of a multi-tenant architecture job tracking system with dynamically altered user interfaces according to an embodiment. Customer list user interface 1400 includes customer status bar 1402 that includes selectable active customer tab 1402 and selectable inactive customer tab 1404. User selection of active customer tab 1402 is shown. A user may add a customer by selection of add customer selector 1406 and alternatively search for a customer via search customer search window 1408. Customer field 1410 includes various customer data fields according to customer attributes selected by the user. These include a customer identification number field 1412 that uniquely identifies a customer, customer name field 1414. Customer address field 1416 contains the customer address necessary for job locations and/or billing address.

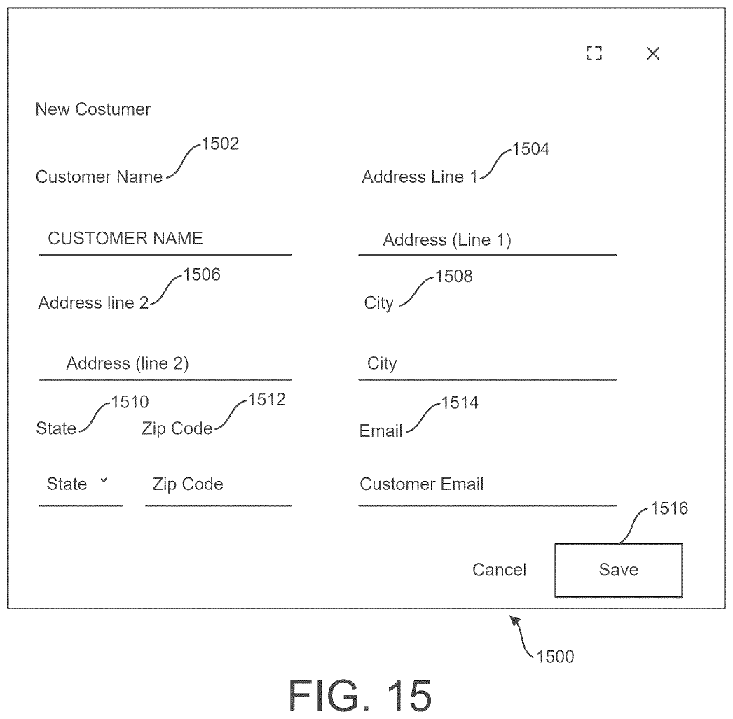

FIG. 15 depicts a new customer user interface of a multi-tenant architecture job tracking system with dynamically altered user interfaces according to an embodiment. When a user selects add customer selector 1406 of FIG. 14, new customer user interface 1500 is presented. This includes various fields for entry of new customer data. These include customer name field 1502, customer address fields 1504 and 1506, customer city field 1508 and state field 1510 and zip code field 1512. The user's email address is entered in email field 1514. The user selects save key 1516, which causes the new user information entered in new customer user interface to appear in customer Geld 1410 of FIG. 14. A user receives an invitation to set their password and log in to the associated portal—either web or mobile—upon user creation.

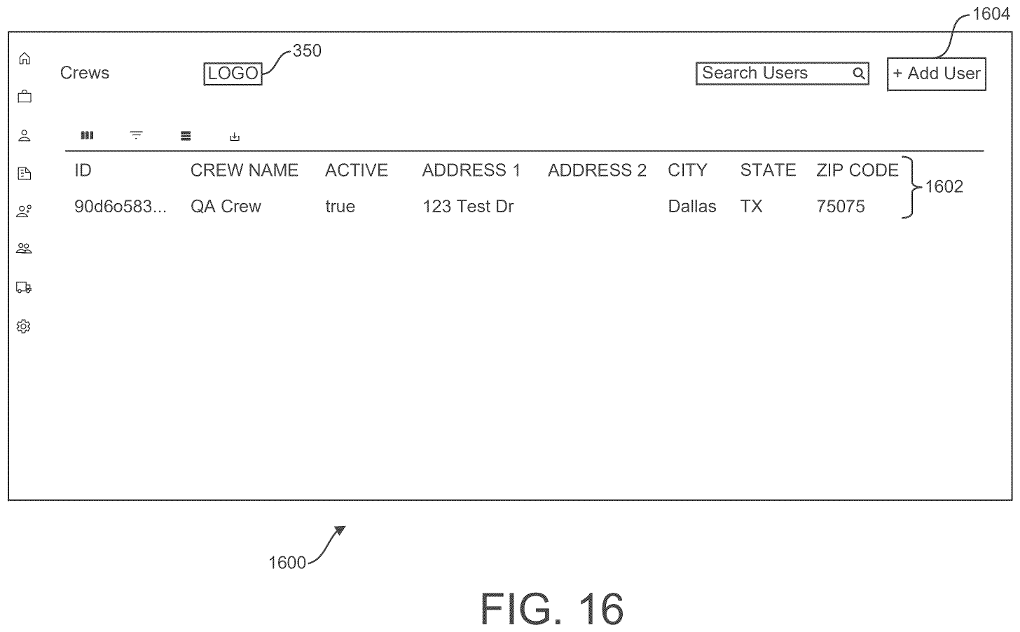

FIG. 16 depicts a crew list user interface of a multi-tenant architecture job tracking system with dynamically altered user interfaces according to an embodiment. Crew list user interface 1600 includes crew data field 1602 that includes data entered corresponding to user selected parameters such as a crew identification number that uniquely identifies the crew, the crew name, whether the crew is active, and the location of the crew. Add crew selector 1604, when selected by the user, presents a new crew interface that permits the user to enter new crew data.

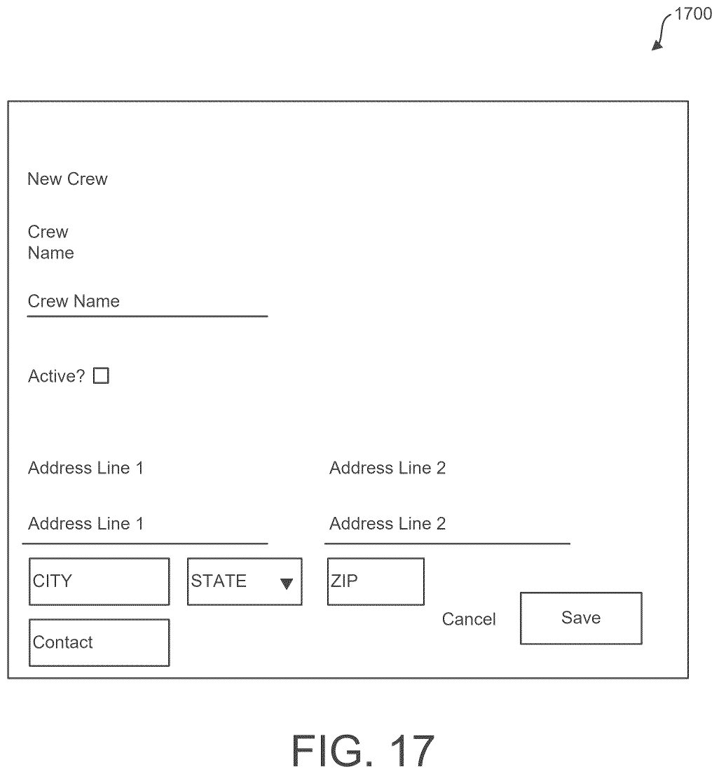

FIG. 17 depicts a new crew user interface of a multi-tenant architecture job tracking system with dynamically altered user interfaces according to an embodiment. New crew user interface 1700 is presented to the user upon selection of add crew selector 1604 as described in connection with FIG. 16. New crew user interface 1700 includes crew name field, a selector for selection when the crew is an active crew, the new crew's address, email address and primary contact name are among the user defined data to be input for a new crew. Once the user saves the new crew data entered via new crew user interface 1700, the crews information on crew user interface 1600 is update to reflect the newly added user.

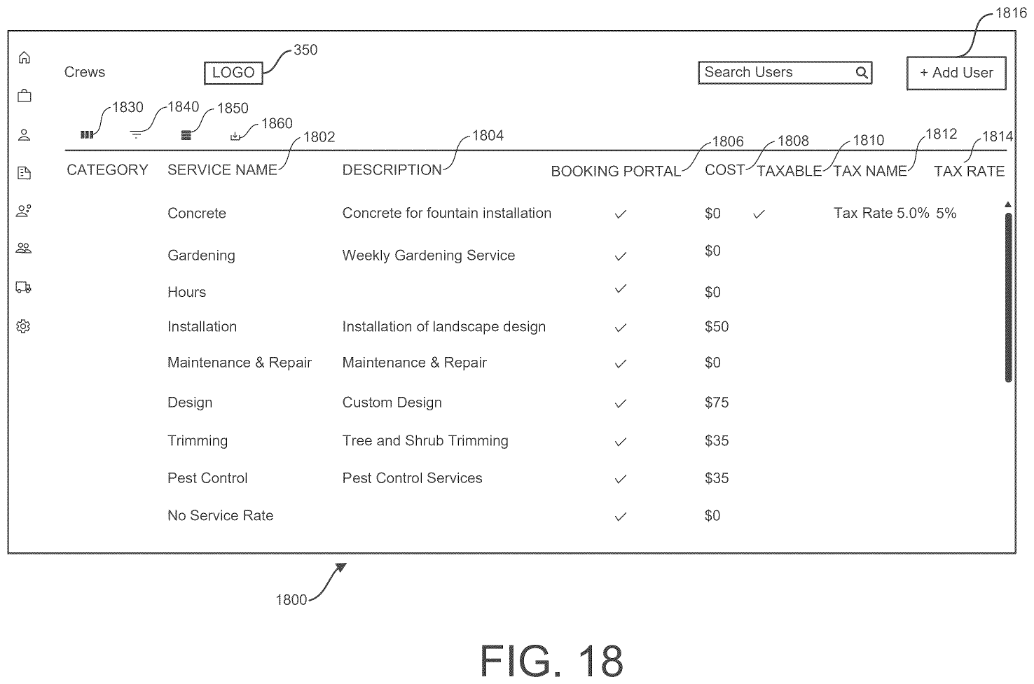

FIG. 18 depicts a service listing user interface of a multi-tenant architecture job tracking system with dynamically altered user interfaces according to an embodiment. Service listing user interface 1800 includes various fields representing user defined parameters of the services provided. Data pertaining to various service parameters are entered or selected from predefined lists in service name field 1802, service description field 1804, booking portal field 1806, cost field 1808, taxable field 1810, identifying where a good or service for this service is taxable, tax name field 1812 and tax rate field 1814. If a service needs to be added by the user, the user selects new service selector 1816.

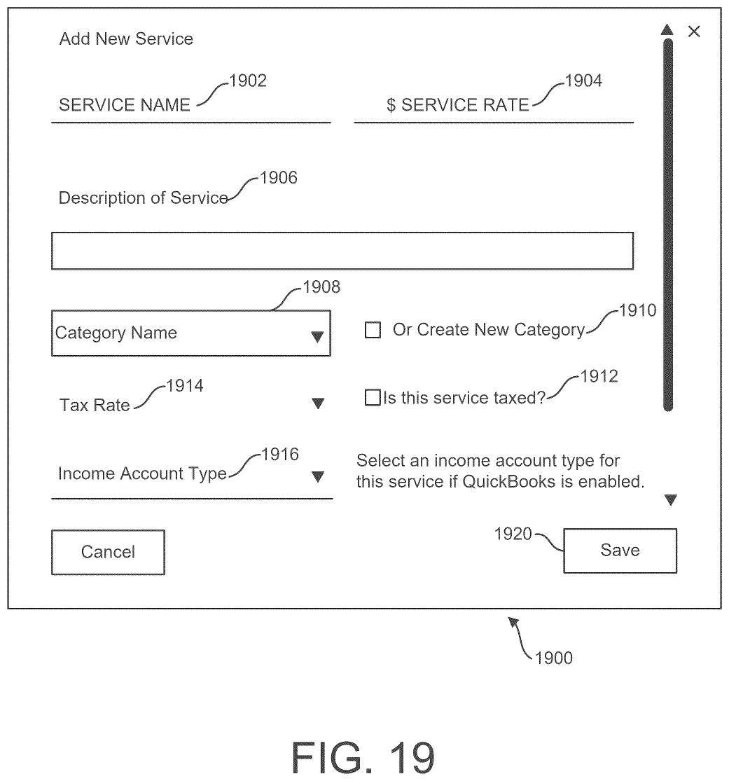

FIG. 19 depicts a new service addition user interface of a multi-tenant architecture job tracking system with dynamically altered user interfaces according to an embodiment. New service addition user interface 1900 is presented to the user upon user selection of new service selector 1816 in FIG. 18. New service addition interface 1900 includes various fields that are populated via selection of an item from a drop down list, manual entry or the like. Fields in new service addition interface 1900 include service name field 1902, service rate field in dollars or other units 1904, service description field 1906, service category 1908, a new category selector 1910 for creation of a new service category, tax rate field 1912, tax rate selector 1912 indicating whether the service entered is taxed, income account type field 1914 which in an embodiment is selected if linked accounting software is enabled. A user saves the added new service information entered via save key 1920, causing the new service to appear on service listing user interface 1800 discussed in connection with FIG. 18.

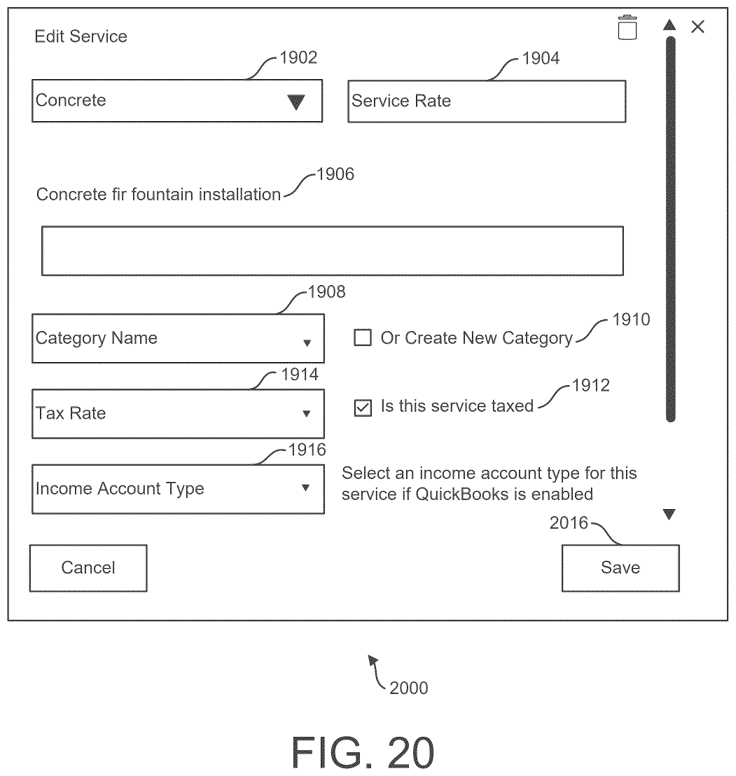

FIG. 20 depicts a service editing user interface of a multi-tenant architecture job tracking system with dynamically altered user interfaces according to an embodiment. Services editing user interface 2000 includes the same fields as new service listing user interface 1900, these include service name field 1902, service rate field in dollars or other units 1904, service description field 1906, service category 1908, a new category selector 1910 for creation of a new service category, tax rate field 1912, tax rate selector 1912 indicating whether the service entered is taxed, income account type field 1914 which in an embodiment is selected if linked accounting software is enabled. A user saves the edits to the preexisting service via selection of edit save key 2016.

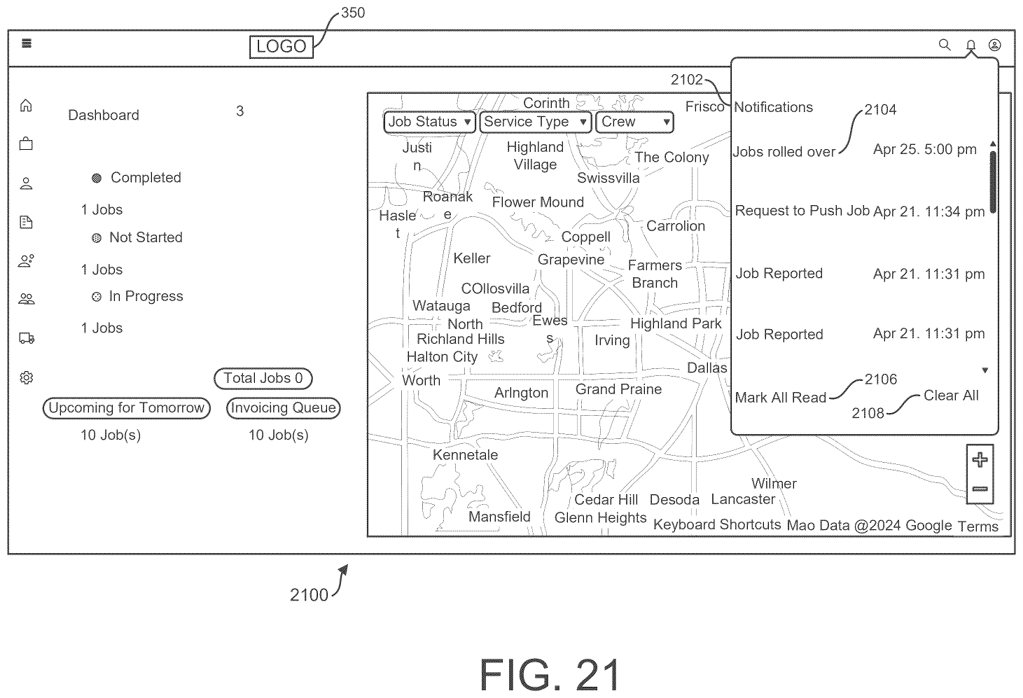

FIG. 21 depicts a user dashboard notification listing user interface of a multi-tenant architecture job tracking system with dynamically altered user interfaces according to an embodiment. In FIG. 21, user dashboard 300 is the same dashboard discussed in connection with FIG. 3. In FIG. 21, however, notification listing 2102 is presented. Notifications listing 2102 include message subjects 2014 providing a high level of detail of a message concerning a job, a data of the message and a more detailed view of its contents. Messages on notifications listing 2012 are marked as read by selection of mark as read key 2106 and message are cleared by user selection of clear key 2108.

Each licensee (Licensee A, B, . . . , etc.) of the presently described embodiments of a multi-tenant architecture job tracking system with dynamically altered user interfaces invokes its own branded version of the frontend user interface application that is determined at runtime according to organization identification, a configuration file, and an assets repository. Upon user login, that licensee's designated colors, loge and theme are inserted into the frontend interface, which permeates the various specific user interfaces herein described. An application program retrieves branded assets, such as a logo or trademark, from, in an embodiment, public cloud storage containers for objects stored in simple storage service (S3) format as designated by the licensee at runtime.

Utilizing an S3 repository allows for real-time updates of the described jobs platform that do not require code deployment. The application programs that provide users with the various interfaces and functionality herein described retrieve a licensee config file by organization ID from an S3 repository to dynamically inject branding such as primary, second, and tertiary colors for the user, either on an individualized basis or entity wide.

The application programs utilize an existing photos S3 repository for photo retrieval and storage for licensees. A new schema is created for each onboarded user for data segmentation and long-term flexibility. A cross-reference table is created to associate an organization ID to a licensee schema. A backend platform operator application program interface (API) dynamically injects the applicable email address to send notifications via a simple mail transfer protocol (STMP) from the licensee's email. The Backend API will leverage the platform operator's existing messaging account, such as Twilio MessagingX, to send SMS notifications to users' crew or customers from a single number and only for forwarding notifications.

Organizations are configured in a platform, such as Auth0 to manage licensees and their subscription, providing secure access to the multi-tenant architecture job tracking platform with dynamically altered user interfaces herein described. The backend application program supports both the platform provider's version of the platform as well as the user/licensee's version of the platform. In an embodiment, the presently described platform relies on a single data store for consistency, although multiple data stores or distributed storage may be employed. The platform operator's integrations with application programs to automate repetitive tasks, host real-time text, voice or video chats, and use visualization tools for data analytics and business intelligence are not impacted from the platform operator's perspective and optionally may be made available to user/licensee's, depending of the user subscription plan. Platform administrators leveraging online software development platforms for storing, tracking or collaborating on developing source code and web hooks for CI/CD are not impacted. At the same time, the platform operator sends monthly insights reports to licensees derived from analytics of customer data.

Platform and user integration with commercially available billing and accounting software allows for basic invoicing functionality. Integration with an address validation service is procured and configured to verify addresses provided for jobs. As described, the various services interface allows end users the ability to manage their service offerings within the platform. The various user interfaces allow user/licensees to tailor their services to their industry and business. Row-level-security is implemented for each licensee and the backend to protect data. A new services management user interface is created to allow users the ability to manage their service offerings within the platform and tailor their services to their industry and business.

The various user interfaced described herein with respect to FIGS. 3-21 provide robust detail data accessible by the user. In an embodiment, the various data items contained in the information field described are selectable by the user to present to the user more detailed data concerning the item selected. For example, selection of a displayed customer on customer user interface 1400 of FIG. 14 presents to the user customer detail screens for the selected customer. This data of a customer is editable by the user as contact information changes, and job contacts for that customer's job are viewable. Also, active and inactive projects for that customer are displayed that are editable by the user, as well as metrics associated with that customer, such as total jobs completed, jobs booked through various sources, the number of active projects and revenue derived from that customer. As this data is updated for a customer, the display of that customer's data through the various interfaces is also updated.

The various information fields herein described within the various user interfaces are presentable in various formats upon user selection of various presentation keys. Presentation keys are shown in the context of FIG. 18, but this serves as just one example. As shown, similar selectable keys are available for user selection in the various interfaces shown. Presentation keys comprise attribute key 1830 through which a use selects which parameters are presented as information fields in a user interface. In FIG. 18, selection of attribute key will present, in one embodiment, a listing of selectable switches to effectively turn off or on display of a parameter item. A user may opt to include a category field among the columns of information but remove the tax name field by activating or deactivating the appropriate switch.

Continuing with FIG. 18, selectable filter key 1840 is selectable by the user, allowing the user in one embodiment to define filters or values that modify the data depicted in the various fields in the user interface. Also, the compactness of spacing of the data in the various fields of the interface, in one embodiment, is controlled by user selection of spacing options presented upon selection of spacing key 1850. The various user interface described herein include download key 1860 that when selected present the user with the option of downloading the data fields as comma separated values (CSV) for importing into other reports, or printing.

The various interfaces herein described are driven by the multi-tenant architecture framework that provides user/licensees with a streamlined yet fully customizable platform for managing and processing job data associated with numerous crews providing number services for many customers. The dynamically altered front end user interfaces generated by a back end multi-tenant architecture platform provides licensee users with a fully customizable data management experience. At the same time, multi-tenant architecture platform operators supply customizable and dynamic user interfaces to a wide array of licensee users, regardless of industry. The customizability and portability of user interfaces generated by a common back end multi-tenant architecture platform provides a patentable advance in the technology of data management, job management and reporting, invoicing and generation of job metrics in terms of making dynamic and robust user interfaces available to users without the large investment in data management infrastructure. User licensees merely subscribe to access of the SaaS offering on a predefined periodic basis for a negotiated fee.

As generally illustrated herein, the system embodiments of the present disclosure can incorporate a variety of non-transitory computer readable media that comprise computer usable medium having computer readable code means embodied therein. One skilled in the art will recognize that the software associated with the various processes described herein can be embodied in a wide variety of computer accessible media from which the software is loaded and activated. The present disclosure includes this type of computer readable media within its scope. The presently disclosed system anticipates a wide variety of variations in the basic theme of construction. The examples presented previously do not represent the entire scope of possible usages. They are meant to cite a few of the almost limitless possibilities. One skilled in the art will recognize that other embodiments are possible based on combinations of elements taught within the above description. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

FIG. 22 depicts an example operating environment of a multi-tenant architecture job tracking system with dynamically altered user interfaces in the embodiments. In FIG. 22, multi-tenant host platform (“host platform”) 210, comprises backend application program interface (API) 2202 and is in communication with one or more SXQL databases 2204 for retrieval of external references and various licensing schemas. Host platform 210 via backend API 2202 communicates with various S3 data buckets, as discussed above, for storage and retrieval of photos to or from photos S3 bucket 2206, configuration files from configuration file S3 bucket 2208 and various assets from S3 bucket 2210. Backend API 2202 communicates with location services module 2270 and its associated address verification application program 2272 to verify location information of various customer job, crew locations, etc. Backend API 2202 is also in communication with invoicing module 2280 for billing services available by commercially available billing and bookkeeping vendors that offer such software as a service to users.

Continuing, backend API 2202 communicates with notifications module 2212 that includes one or more email notifications application programs 2214 and one or more SMS notifications application programs 2216 for receipt and transmission of notifications between licensee users (administrators, crews, customers) and between the platform host and such users.

Third party integrations module 2250 of host platform 210 include automation web application programs 2252 in communication with notification module 2212 and email notifications application program 2214 and SMS notifications application program 2216. Third party integrations module 2250 of host platform 210 further includes notifications application programs 2254 in communication with web integration application programs 2252 and reporting application program 2256 that communicates with SQL database 2204. Backend API 2202 communicates with host platform web portal 2290 for desktop users and with host platform mobile client/trade partners mobile application programs 2292 for both iOS and android users. Source code control module 2262 communicates with host platform 210 as does third party user authentication mode 2260 for securely assigning and administrating login credentials of users.

Multiple users communicate with the multi-tenant host platform 210 for proving job tracking through dedicated dynamically altered frontend user interfaces as described. A first user (User 1) communicates through first user interface module 2220, which is described above as the many front end user interfaces of the job tracking platform. First user interface module 2220 communicates with host platform 210 to leverage the many features and functionality described herein, via web portal 2222. First user interface module 2220 further comprises host platform mobile client/trade partners mobile application programs 2224 for both iOS and android users through which interface customization, data entry, updates, additions of new customers, crews, jobs, etc. are executed by the user.

A second user (User 2) communicates through second user interface module 2230, which is described above as the many front end user interfaces of the job tracking platform. Second user interface module 2230 communicates with host platform 210 to leverage the many features and functionality described herein, via web portal 2232. Second user interface module 2230 further comprises host platform mobile client/trade partners mobile application programs 2234 for both iOS and android users through which interface customization, data entry, updates, additions of new customers, crews, jobs, etc. are executed by the user.

Administrative user interface 2240, which includes services management user interface 2242, communicates with first user interface module 2220 and second user interface module 2230 and host platform 210 that allows users the ability to manage their respective services offerings within host platform 201. Services management user interface 2242 allows the user to tailor services according to their specific industry and business needs and preferences.

The previously described embodiments are for illustrative purposes only and are by no means limiting and represent an embodiment for carrying out the many embodiments described herein, include the various features and functionality of the among the many embodiments of the herein described multi-tenant architecture job tracking system with dynamically altered user interfaces. The robustness of the system of the present invention is achievable in various configurations as would be apparent to one of ordinary skill in the art.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

### Additional Disclosure

Clause 1. A system built on a multi-tenant architecture platform for processing and tracking jobs, comprising:
a processor; and
a computer-readable medium storing instructions that, when executed by the processor, cause the processor to manage a tenant user job in a multi-tenant cloud-based workflow management system, the managing comprising:
defining one or more customizable user interfaces;
creating one or more applications for one or more tenants of the multi-tenant cloud-based workflow management system using the one or more user interfaces;
assigning user roles to one or more users, the one or more user roles comprising an administrative user, a customer user, a crew manager user and a crew member user;
applying a first job attribute to a first of the at least one of the one or more user interfaces of a first user;
in response to the applying of the first job attribute, updating a job listing status table associated with the first user;
adding a job order associated with the first user, comprising a service date, a service type, and a service recipient;
automatically updating the job listing status table associated with the first user in response to the adding of the job order;
revising the job listing status table according to a job progress update entered by the user;
invoking an invoicing module for creating a customer invoice upon completion of the tenant user job.
   Clause 2. The system of any preceding or proceeding clause, further comprising a location services module for verifying an address of the job listing.
   Clause 3. The system of any preceding or proceeding clause, farther comprising an assets data store for storing and retrieval of user branding information by the user for customization of the defined one or more of the customizable user interfaces.
   Clause 4. The system of any preceding or proceeding clause, further comprising a multimedia data store for storing and retrieval of visual information for display on the defined one or more of the customizable user interfaces.
   Clause 5. The system of any preceding or proceeding clause, further comprising a notification generating module for providing notifications via a user dashboard regarding an updated job status.
   Clause 6. The system of any preceding or proceeding clause, wherein the notification is a short messaging service (SMS) message.
   Clause 7. The system of any preceding or proceeding clause, wherein the notification is an e-mail message.
   Clause 8. A non-transitory computer readable medium having instructions stored thereon that, when executed by a processor associated with a multi-tenant architecture platform, cause the processor to generate customizable user interfaces and job tracking and invoicing information for a plurality of tenants, comprising:
defining one or more customizable user interfaces;
creating one or more applications for one or more tenants of the multi-tenant cloud-based workflow management system using the one or more user interfaces;
assigning user roles to one or more users, the one or more user roles comprising an administrative user, a customer user, a crew manager user and a crew member user;
applying a first job attribute to a first of the at least one of the one or more user interfaces of a first user;
in response to the applying of the first job attribute, updating a job listing status table associated with the first user;
adding a job order associated with the first user, comprising a service date, a service type, and a service recipient;
automatically updating the job listing status table associated with the first user in response to the adding of the job order;
revising the job listing status table according to a job progress update entered by the user;
invoking an invoicing module for creating a customer invoice upon completion of the tenant user job.
   Clause 9. The non-transitory computer readable medium of any preceding or proceeding clause, further comprising verifying an address of the job listing.
   Clause 10. The non-transitory computer readable medium of any preceding or proceeding clause, further comprising storing and retrieval from an asset data store of user branding information by the user for customization of the defined one or more of the customizable user interfaces.
   Clause 11. The non-transitory computer readable medium of any preceding or proceeding clause, further comprising storing and retrieval of visual information from a multimedia data store for display on the defined one or more of the customizable user interfaces.
   Clause 12. The non-transitory computer readable medium of any preceding or proceeding clause, further comprising generating notifications via a user dashboard regarding an updated job status.
   Clause 13. The non-transitory computer readable medium of any preceding or proceeding clause, wherein the notification is a short messaging service (SMS) message.
   Clause 14. The non-transitory computer readable medium of any preceding or proceeding clause, wherein the notification is an e-mail message.
   Clause 15. A method for processing and tracking jobs according to multi-tenant architecture techniques, comprising the steps of:
defining one or more customizable user interfaces;
creating one or more applications for one or more tenants of the multi-tenant cloud-based workflow management system using the one or more user interfaces;
assigning user roles to one or more users, the one or more user roles comprising an administrative user, a customer user, a crew manager user and a crew member user;
applying a first job attribute to a first of the at least one of the one or more user interfaces of a first user;
in response to the applying of the first job attribute, updating a job listing status table associated with the first user;
adding a job order associated with the first user, comprising a service date, a service type, and a service recipient;
automatically updating the job listing status table associated with the first user in response to the adding of the job order;
revising the job listing status table according to a job progress update entered by the user;
invoking an invoicing module for creating a costumer invoice upon completion of the tenant user job.
   Clause 16. The method of any preceding or proceeding clause, further comprising the step of verifying an address of the job listing.
   Clause 17. The method of any preceding or proceeding clause, further comprising the steps of storing and retrieval from an asset data store of user branding information by the user for customization of the defined one or more of the customizable user interfaces.
   Clause 18. The method of any preceding or proceeding clause, further comprising the steps of storing and retrieval of visual information from a multimedia data store for display on the defined one or more of the customizable user interfaces.
   Clause 19. The method of any preceding or proceeding clause, further comprising the steps of, further comprising generating notifications via a user dashboard regarding an updated job status.
   Clause 20. The method of any preceding or proceeding clause, wherein the notification is a short messaging service (SMS) message.
   Clause 21. The method of any preceding clause, wherein the notification is an e-mail message.

What is claimed is:

1. A system built on a multi-tenant architecture platform for processing and tracking jobs, comprising:
a processor; and
a computer-readable medium storing instructions that, when executed by the processor, cause the processor to manage a tenant user job in a multi-tenant cloud-based workflow management system, the managing comprising:
defining one or more customizable user interfaces;
creating one or more applications for one or more tenants of the multi-tenant cloud-based workflow management system using the one or more user interfaces;
assigning user roles to one or more users, the one or more user roles comprising an administrative user, a customer user, a crew manager user and a crew member user;
applying a first job attribute to a first of the at least one of the one or more user interfaces of a first user;
in response to the applying of the first job attribute, updating a job listing status table associated with the first user;
adding a job order associated with the first user, comprising a service date, a service type, and a service recipient;
automatically updating the job listing status table associated with the first user in response to the adding of the job order;
revising the job listing status table according to a job progress update entered by the user;
invoking an invoicing module for creating a customer invoice upon completion of the tenant user job.

2. The system of claim 1, further comprising a location services module for verifying an address of the job listing.

3. The system of claim 1, further comprising an assets data store for storing and retrieval of user branding information by the user for customization of the defined one or more of the customizable user interfaces.

4. The system of claim 1, further comprising a multimedia data store for storing and retrieval of visual information for display on the defined one or more of the customizable user interfaces.

5. The system of claim 1, further comprising a notification generating module for providing notifications via a user dashboard regarding an updated job status.

6. The system of claim 5, wherein the notification is a short messaging service (SMS) message.

7. The system of claim 5, wherein the notification is an e-mail message.

8. A non-transitory computer readable medium having instructions stored thereon that, when executed by a processor associated with a multi-tenant architecture platform, cause the processor to generate customizable user interfaces and job tracking and invoicing information for a plurality of tenants, comprising:
defining one or more customizable user interfaces;
creating one or more applications for one or more tenants of the multi-tenant cloud-based workflow management system using the one or more user interfaces;
assigning user roles to one or more users, the one or more user roles comprising an administrative user, a customer user, a crew manager user and a crew member user;
applying a first job attribute to a first of the at least one of the one or more user interfaces of a first user;
in response to the applying of the first job attribute, updating a job listing status table associated with the first user;
adding a job order associated with the first user, comprising a service date, a service type, and a service recipient;
automatically updating the job listing status table associated with the first user in response to the adding of the job order;
revising the job listing status table according to a job progress update entered by the user;
invoking an invoicing module for creating a customer invoice upon completion of the tenant user job.

9. The non-transitory computer readable medium of claim 8, further comprising verifying an address of the job listing.

10. The non-transitory computer readable medium of claim 8, further comprising storing and retrieval from an asset data store of user branding information by the user for customization of the defined one or more of the customizable user interfaces.

11. The non-transitory computer readable medium of claim 8, further comprising storing and retrieval of visual information from a multimedia data store for display on the defined one or more of the customizable user interfaces.

12. The non-transitory computer readable medium of claim 8, further comprising generating notifications via a user dashboard regarding an updated job status.

13. The non-transitory computer readable medium of claim 12, wherein the notification is a short messaging service (SMS) message.

14. The non-transitory computer readable medium of claim 12, wherein the notification is an e-mail message.

15. A method for processing and tracking jobs according to multi-tenant architecture techniques, comprising the steps of:
defining one or more customizable user interfaces;
creating one or more applications for one or more tenants of the multi-tenant cloud-based workflow management system using the one or more user interfaces;
assigning user roles to one or more users, the one or more user roles comprising an administrative user, a customer user, a crew manager user and a crew member user;
applying a first job attribute to a first of the at least one of the one or more user interfaces of a first user;
in response to the applying of the first job attribute, updating a job listing status table associated with the first user;
adding a job order associated with the first user, comprising a service date, a service type, and a service recipient;
automatically updating the job listing status table associated with the first user in response to the adding of the job order;
